(19) United States
(12) Patent Application Publication
(10) Pub. No.: US 2002/0092878 A1
(43) Pub. Date: Jul. 18, 2002

(54) Electronic dispenser

(76) Inventors: Ian William Seton, Kurrajong (AU); Joan Mary Seton, Kurrajong (AU)

Correspondence Address: CESARI AND MCKENNA, LLP, 88 BLACK FALCON AVENUE, BOSTON, MA, 02210, US

(21) Appl. No.: 09/761,292

(22) Filed: Jan. 16, 2001

(51) Int. Cl. B67D 3/00; B67D 5/06

(52) U.S. Cl. 222/504; 222/23; 222/559

(57) ABSTRACT

A device for dispensing particulate material in a controlled manner, said device being portable and including:

a particulate material storage compartment;

a channel to transfer the particulate material from the storage compartment to a discharge region;

a gate valve, the gate valve passing through a slot in the channel wall, the slot disposed intermediate to the storage compartment and the discharge region; and

electronic control means to actuate the gate valve.

The device can be embodied as an automated and immobile device.

In a preferred form, the channel has a discontinuity in cross-sectional area in the vicinity of the gate valve whereby the cross-sectional area of the channel in a first region, the first region being on the storage compartment side of the gate valve, is less than the cross-sectional area of the channel in a second region, the second region being on the discharge region side of the gate valve.

### TECHNICAL FIELD

The present invention relates to a new type of electronic dispenser, and in particular, to a device for dispensing particulate material in variable quantities, the actual quantity of dispensed particulate material being controlled by electronic means.

### BACKGROUND ART

In many situations particulate material is required to be delivered to some target, the quantity of delivered particulate material required to be within a specified degree of accuracy.

Presently, methods and devices for delivering particulate material, such as physically selecting a fixed quantity of particulate material using a container are well known. Also, methods and devices are known whereby a fixed quantity of particulate material may be delivered by weight. However, both these methods and the devices for their implementation have the disadvantages that they are relatively cumbersome both in principle and in their physical operation.

Furthermore, these and other known methods and devices often rely on mechanical modes of operation. In many situations mechanical operation means can limit the speed and efficiency of delivering particulate material.

Certain identified documents disclose electronically controlled means for the dispensing of particulate material to a target. DE 4026879 teaches of a shutter being disposed across an outlet, the shutter actuated by a hydraulic cylinder. The quantity of dispensed material is controlled by electronic memory. U.S. Pat. No. 5,735,231 discloses an automatic dog and cat feeder having timers for the releasing of feed material at programmed times. A solenoid operates a valve incorporated into the device. U.S. Pat. No. 5,870,906 teaches of an automatic dispensing device for washing machines. A gravity based dispenser utilises an electrical solenoid based valve assembly to release material from a storage reservoir. U.S. Pat. No. 4,378,078 discloses a device for dispensing a measured quantity of granulated material to a container. An electro-responsive pivoted dispensing valve is provided to interrupt the flow of granulated material.

However, in all of the aforementioned devices mobility or portability of the device is limited. Furthermore, the devices are not readily able to direct the output flow of particulate material to a target location other than the predetermined target location of interest. Changes in the physical location of a is target/s limit the operation of the devices. This is linked with the limited mobility or portability of the aforementioned devices.

The devices disclosed in the identified documents have specific applications and cannot function as general purpose particulate material dispensers having broad application due to portability, mobility, manoeuvrability, transportability and/or ease of carrying by a user.

For example, in a non-limiting application, the delivery of fertiliser as a particulate material to plants, is presently limited to known methods and devices of the prior art such as the methods and devices hereinbefore disclosed,

Furthermore, presently known devices do not provide a relatively mobile device for dispensing particulate material to a target, especially a device which can be carried by a single operator or user as they move between multiple target locations.

Another problem encountered in types of particulate material dispensers is the obstruction of a shutter or valve closing mechanism which regulates the flow of the particulate material. The shutter or valve can be obstructed by the particles of the particulate material itself when the shutter or valve is attempted to be closed. This can lead to damage of components of the dispenser and/or the particles if they are pressure sensitive.

This identifies a need for an improved or new type of dispenser for particulate material which overcomes the problems inherent in the prior art.

The reference to any prior art in this specification is not, and should not be taken as, an acknowledgment or any form of suggestion that that prior art forms part of the common general knowledge in Australia.

### DISCLOSURE OF INVENTION

The present invention seeks to provide a dispensing device whereby the gravitational movement of particulate free-flowing material through a delivery channel can be started and stopped without any obstruction to the operation of a control device by the particulate material, and without any significant damage to the particulates of the material themselves.

The present invention also seeks to provide an electronic dispenser for particulate material whereby a variable controlled quantity of particulate material can be delivered to some target.

The present invention also seeks to provide an electronic dispenser for particulate material whereby the electronic dispenser is transportable and can be carried by a user between target locations.

The present invention also seeks to provide an electronic dispenser for particulate material whereby the electronic dispenser is a general purpose particulate material dispenser having broad application due to portability, mobility, manoeuvrability, transportability and/or ease of carrying by a user.

The present invention also seeks to provide an electronic dispenser for particulate material whereby the electronic dispenser is constructed such that particulate material will not obstruct the closure of a particulate material flow regulating valve (gate valve).

The present invention further seeks to provide an electronic dispenser for particulate material, the particulate material being of variable dimensions, homogeneous, inhomogeneous, dry or many other types of variations which may be encountered, whereby a variable controlled quantity of particulate materials may be delivered to some target.

Accordingly, the present invention seeks to provide these and other objects or features providing an electronic dispenser for particulate materials.

In accordance with a specific embodiment of the present invention there is provided a device for dispensing particulate material in a controlled manner, said device being portable and including:

a particulate material storage compartment;

a channel to transfer the particulate material from the storage compartment to a discharge region;

a gate valve, the gate valve passing through a slot in the channel wall, the slot disposed intermediate to the storage compartment and the discharge region: and

electronic control means to actuate the gate valve.

Preferably, the device is provided with carrying or support means to aid in the portability of the device.

In accordance with a further specific embodiment of the present invention there is provided a device for dispensing particulate material in a controlled manner, said device being automated and immobile, and including:

a particulate material storage compartment;

a channel to transfer the particulate material from a storage compartment to a discharge region;

a gate valve, the gate valve passing through a slot in the channel wall, the slot disposed intermediate to the storage compartment and the discharge region; and

electronic control means to actuate the gate valve.

In a further broad form of the present invention, the channel has a discontinuity in cross-sectional area in the vicinity of the gate valve whereby the cross-sectional area of the channel in a first region, the first region being on the storage compartment side of the gate valve, is less than the cross-sectional area of the channel in a second region, the second region being on the discharge region side of the gate valve.

In a further broad form of the present invention, at least part of the channel is tapered along the channel's longitudinal length.

In accordance with a specific embodiment of the present invention the channel includes a distinct step in the vicinity of the gate valve.

In accordance with a specific embodiment of the present invention the channel has a substantially uniform cross-sectional area along the longitudinal length of the channel.

In a broad form, the cross-sectional geometry of the channel is any shape.

In accordance with an embodiment of the present invention the device is provided with electronic means to control the duration for which the gate valve is in an open position.

Preferably, the device is provided with electronic means to control the width of a gap produced when the gate valve is in the open position.

In a further embodiment of the present invention the device derives electrical power from any of the following means: battery; re-chargeable battery; mains; stored capacitive and/or solar.

In yet a further embodiment of the present invention the device includes indicators to show the status of the device.

In yet a further embodiment of the present invention the device includes warning indicators.

In accordance with a specific embodiment of the present invention actuation means to actuate the gate valve includes at least one solenoid.

In accordance with a further specific embodiment of the present invention the gate valve is a substantially planer sheet of substantially rigid material.

Also preferably, when the gate-valve is in a closed position there remains a gap between the gate valve and the channel wall.

In a further embodiment of the present invention the device is controlled by, or communicates with, a computer or the like.

In a further embodiment of the present invention the gate valve is an air-operated gate valve or the like.

In another preferred form of the invention there is provided a portable electronic particulate material dispenser, substantially according to the embodiment described in the specification with reference to and as illustrated in the accompanying figures.

In another preferred form of the invention there is provided an immobile automated electronic particulate material dispenser, substantially according to the embodiment described in the specification with reference to the accompanying figures.

### BRIEF DESCRIPTION OF FIGURES

The present invention will become better understood from the following detailed description of a preferred but non-limiting embodiment thereof, described in connection with the accompanying figures, wherein;

FIG. 1 illustrates a preferred embodiment of the present invention wherein, the figure shows the storage end of the electronic dispenser.

FIG. 2 illustrates a preferred embodiment of the present invention wherein, the figure shows the control, electronics and dispensing end of the electronic dispenser.

FIG. 3 illustrates an embodiment of the present invention wherein, the figure shows a simplified representation of the valve when closed.

FIG. 4 illustrates an embodiment of the present invention wherein, the figure shows a simplified representation of the valve when obstructed by particulate material.

FIG. 5 illustrates a further preferred embodiment of the present invention wherein, the figure shows a simplified representation of an alternative embodiment of the gate valve and channel when the gate valve is open.

FIG. 6 illustrates a further preferred embodiment of the present invention wherein, the figure shows a simplified representation of an alternative embodiment of the gate valve and channel when the gate valve is closed.

FIG. 7 illustrates a preferred embodiment of the present invention wherein, the figure shows a schematic to aid in calculation of the gap distance ‘x’ and other distances.

### MODES FOR CARRYING OUT THE INVENTION

The present invention provides an electronic dispenser. In the figures, incorporated to illustrate the features of the present invention, like reference numerals are used to identify like parts throughout the figures.

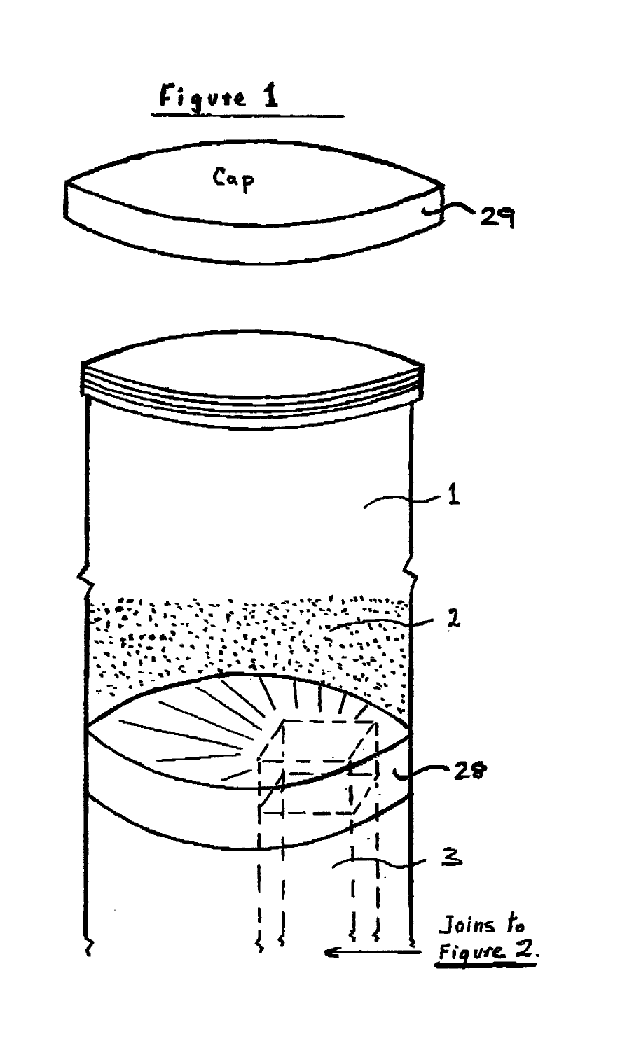

A preferred, but non-limiting, embodiment of the present invention is shown in FIGS. 1 and 2. A storage compartment 1 holds a quantity of particulate material 2, a channel 3 is joined to the storage compartment 1 and allows the particulate material 2 to reach the discharge region 4.

The retaining and support disc 28 assists to house the particulate material 2 and to support the weight of the particulate material 2. A removable cap 29 allows particulate material 2 to be added to the storage compartment 1 when desired. The is removable cap 29 can be attached to the body of the device by a variety of means, for example, by a thread, clamp, clip and receptacle, abutting or flush fit, hinge or any other means. By way of example only, the removable cap 29 is shown in FIG. 1 as being threaded onto the body of the device.

It should be noted that the device can be readily constructed in a variety of dimensions. The dimensions shown in the figures should not be taken to limit the scope of the present invention. For example, the storage compartment and/or channel 3 may be lengthened or widened. Furthermore, the present embodiment of the invention need not be in a linear arrangement. For example, the storage compartment 1 could readily be provided in a perpendicular arrangement to the channel 3 if so desired. Such variations in geometry or configuration could also be applied to other components of the device, such as the discharge region 4 or the removable cap 29, for example. Additionally, in alternate embodiments the outside device geometry and the channel 3 need not be of circular and quadrilateral cross-section, respectively, as is illustrated in the figures. Any cross-sectional geometry could be applied to these and other components of the device.

A battery 5 is provided as a source of electrical energy. The electrical energy means may be alternatively provided by external means, such as AC mains power being connected to the device when an appropriate transformer is in place. The battery 5 may be rechargeable or not. Furthermore, recharging could take place by utilising solar cells. A solid state timer 6 is linked to a potentiometer 7 (or solid state equivalent), such that adjustment of the potentiometer 7 varies the duration of the time which will elapse before a “time out” signal is given, thereby cutting off the flow of particulate material 2 to the discharge region 4.

A solid state switching controller 8 is also linked to timer 6. Solid state circuit 9 controls a warning system 10, the warning system 10 may be a buzzer, siren, light-emitting device (L.E.D.), or any other type of known warning or indicating device. The operation of the warning system 10 is further disclosed hereinafter.

In practice, the timer 6, switching controller 8, circuit 9, warning system 10 and some of the other controls and indicators subsequently described herein can all be combined in the form of one or more printed circuit boards or solid state electronic chips, or other form of integrated circuit.

An electronic solenoid or solenoids 11 are linked to a switching controller device 8. The solenoid or solenoids may be of the magnetically latching type. Hereinafter the embodiment presented will refer to solenoids, however, it should be noted that a singular solenoid may be used, and indeed, in some situations may be preferential. When the solenoids used are of the magnetically latching type, the gate valve 12 is held firmly in a semi-closed status when in the position 20, even when there is no power connected to the solenoids 11.

Activation of said solenoids 11 is by direction from the switching controller 8, firstly to release the solenoids 11 from their closed position (with assistance from springs 23) and thereby to open the gate valve 12 from its semi-closed position 20, and secondly to close the solenoids 11 and thereby to semi-close the gate valve 12. Solenoid plungers 21 have limiters 22 which pre-determine the extent of opening of the solenoids and thus of the gate valve.

It should be noted that the solenoids 11 are normally used to move the gate valve 12 and to retain the gate valve in the semi-closed position 20 as explained above. However, the gate valve 12 could be activated and retained by other means, for example, by compressed air and some other latching device, both being activated by the switching controller 8.

A thin sheet, or sheets, of stainless steel shaped as a gate valve 12 are utilised to close, semi-close, and to open, the orifice 13 of the channel 3. The gate valve 12 controls the flow of particulate material 2 from the storage compartment 1 to the discharge region 4.

A narrow slot 14 in one side of the channel 3, and at right angles (or any other desired angle) to the direction of flow of material 2 down the channel 3, is utilised so that the gate valve 12 associates closely within the slot 14 and the interior of channel 3, yet allows free movement of the gate valve 12 within the slot 14 and the channel 3.

An assembly 15 links the solenoids 11 to the gate valve 12 such that operation of the solenoids 11 causes the gate valve 12 to open and to semi-close or close within specified limits, thus controlling the passage of the particulate material 2.

In a preferred embodiment of the present invention, the hereinbefore mentioned components can be electrically and/or electronically linked to control devices, such control devices can include:

a) a switch 16 for operational status, viz. run, stop, battery charging or the like.

b) a switch 17 to trigger commencement of each cycle as defined hereinafter.

c) a potentiometer 7 or similar device linked to the timer 6, to enable the user or an electronic sensor to select and to vary the amount of particulate material 2 delivered in each cycle.

d) a socket 18 to receive a plug for charging of the battery 5.

e) an indicator 19 representing the status of the battery 5 when the device is in use and also during the charge process, when applicable.

When in operation, the storage compartment 1 storing particulate material 2 is located at a level above that of the gate valve 12 so that a gravitational feed will operate satisfactorily.

When the device is not cycling, the gate valve 12 is in the semi-closed position 20 with the stored particulate material 2 being blocked by the gate valve 12.

A cyclc includes:

a) initiation of cycle (by either manual or automated means).

b) by direction from the electronic controls to the solenoids, opening of the gate valve 12 to allow material 2 to flow from the storage compartment 1 to the discharge region 4.

c) upon opening of the gate valve 12 the timer 6 starts to measure duration of time since the gate valve opening commenced. When the required time has elapsed the solenoids 11 move the gate valve 12 to its semi-closed position, thereby stopping delivery of further particulate material 2.

Note that alternate sources of electricity or power other than a battery may be used, for example, mains power. When the battery 5 is the source of electricity, the warning device 10 is linked to the battery 5 and to the circuit 9. When the voltage of the battery falls to a level where recharging is necessary for satisfactory operation, the circuit 9 changes status such that whenever trigger 17 (or automatic equivalent ) is activated and also when the voltage falls below a lower predetermined level, even without activation of the trigger 17, the warning device 10 will also be activated. This status of the circuit 9 remains effective until the battery is recharged or is replaced by a charged battery.

The device can operate as a particulate material dispenser having broad application. The device can be provided as a portable, cartable or mobile unit which can be carried by a user. For example, the device can be provided with a shoulder strap, handle or other carrying means to allow a user to aim and activate the device to dispel particulate material 2 to a target. The relatively light-weight and compact design of the device allow the device to attain portability, mobility, manoeuvrability, transportability and/or ease of carrying by a user. Hence, a user can move between targets and release controlled quantities of particulate material 2 onto a selected target.

In a non-limiting specific example, a user could utilise the device to fertilise plants, spread over an area, with particulate fertiliser material. Generally, the device could assist a user in any type of application where multiple targets exist requiring application of a particulate material.

In a further preferred embodiment of the present invention, the device may be located in a fixed location. One or more discharge regions could be provided to serve one or more targets in fixed locations. Note that in this case of an automated application of the device, the battery may be replaced by another power source, and the switch 17 may be replaced by an electronic sensor transmitting to the timer, either directly or via a computer, the initiation of each cycle and all data required to control the opening time of the gate valve 12.

A relatively large mount of particulate material could be held in the storage compartment, the storage compartment illustrated in the figures is by way of example only. For example, a large reservoir of particulate material could be used if the invention is embodied as an automated system serving one or multiple targets requiring particulate material. Furthermore, the cycles may be initiated at any time intervals as dictated by current requirements.

In some cases, the electronic sensor which may replace the switch 17 to initiate the cycles could change the delivery quantity from cycle to cycle. For example, the delivery quantity may be obtained from reading a bar-code and/or data stored in a computer linked to the electronic controls 6 and 8.

When the relative sizes of the particles forming the particulate material 2 being dispensed are either uniform or of various sizes in approximately equal number, (as is usually the case with fertilisers), all flow is arrested when the gate valve 12 is set such that its movement towards closure is stopped at a point 20 where the remaining gap between the gate valve 12 and the body of the channel 3 carrying the particulate material 2 is approximately equal to the diameter of the largest of those particles. This arrangement has the advantage that problems of obstruction are then reduced.

The movement of particulate material 2 as described may be controlled by means of a form of gate valve which can be moved across the channel carrying the particulate material. In many cases this arrangement is quite satisfactory, particularly where substantial force is appropriate to ensure gate valve closure against particulate material such as road-gravel, or soils used in plant nurseries.

In some other cases, there are problems and an alternative embodiment of the invention may be used. The particulate material 2 may, in some situations, occasionally offer a degree of obstruction to a gate valve which may be closed without adequate force, for example, magnetically. Hence, the flow may not be sufficiently arrested. Such a situation occurs as a result of the channel being of a uniform dimension around the location of the gate valve. FIG. 3 represents an illustration of the gate valve 12 in a closed position.

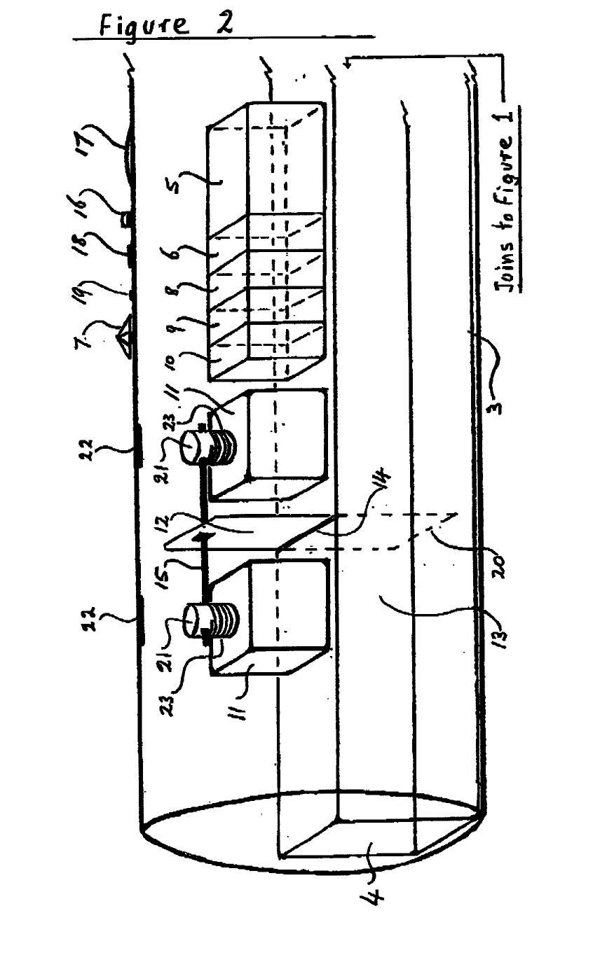

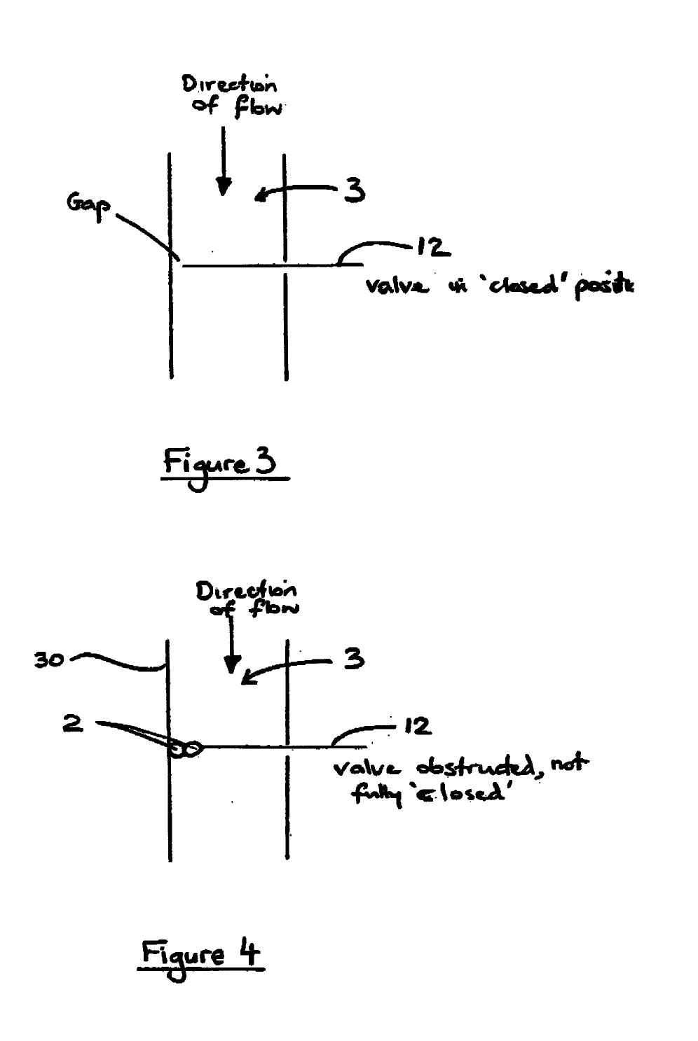

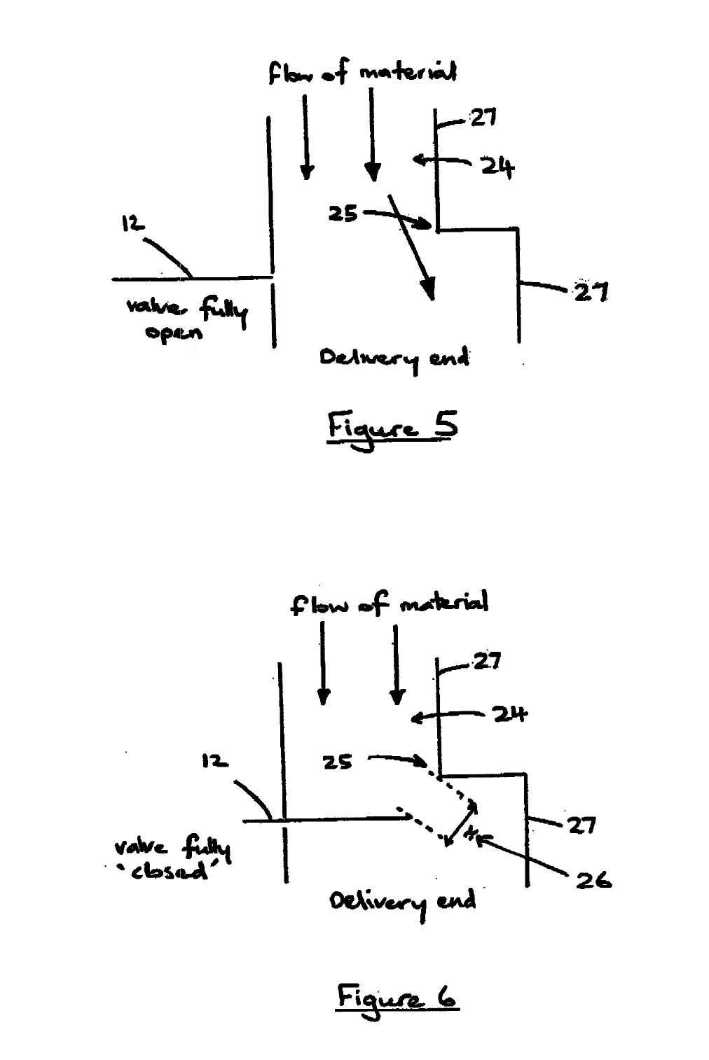

Furthermore, closure of the gate valve is critical where the particles forming the particulate material must not be damaged, for example, controlled-release fertiliser in the form of prills coated with materials which are critical to the longevity of the release process. FIG. 4 represents an illustration of an instance where damage is likely. In this instance, as illustrated, the gate valve 12 is not fully closed as the gate valve 12 has been obstructed by particulate material 2, thus not fully arresting the flow of further particulate material 2 alongside the obstruction, between the partially-open gate valve 12 and the floor 30 of the channel 3.

In a further preferred embodiment of the present invention these problems which may arise are overcome by the following means which are described with reference to FIGS. 5 and 6.

The floor 27 of the channel 24 is provided with a step 25 in the vicinity of the gate valve 12. When the gate valve 12 is fully open, as shown in FIG. 5, particulate material 2 can flow to the discharge region 4 uninhibited. As is shown in FIG. 6, the gate valve 12, when closed, is located such that the gate valve is within the expanded region of the channel 24, and the gate valve does not cross a line defined by the floor of the narrower region of the channel 24. Hence, there is some distance ‘x’ 26 which is defined as the distance from the end of the gate valve 12 to the corner of the step 25 of the channel 24. The distance ‘x’ may be determined by any manner but is generally related to the average size of the particulate material 2.

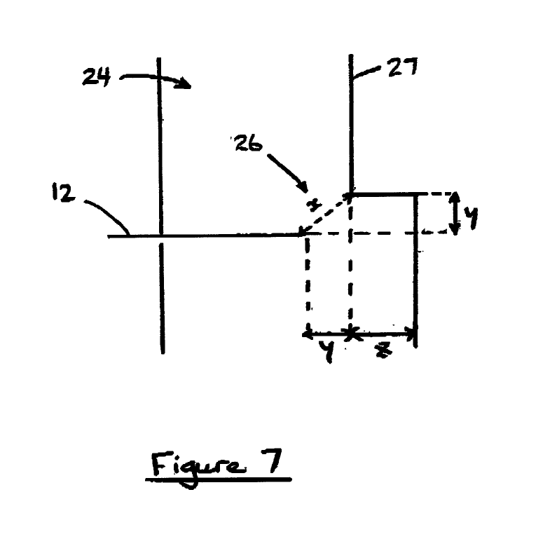

With reference to FIG. 7, one method of determining the distance ‘x’ is hereinafter given. It should be noted that the following method is by way of example only and should not be taken to limit the scope of the invention. If the particles of the particulate material have an average diameter ‘d’, then the distances shown in FIG. 7 may be calculated as x=1.5d, y=\sqrt{x²/2}>x or z=x. Numerous other methods of determining the distances may be utilised.

At one extreme of its movement the gate valve is still only partially closed, that is semi-closed, as was disclosed in a preceding embodiment of the invention. However, using a partial closure of the gate valve in this configuration completely stops the flow of particulate material due to the bridging of the gate valve-channel gap ‘x’ by particles of the particulate material itself. In this configuration, particulate material does not prevent movement of the gate valve 12 to the gate valve's appropriate position, and the particulate material 2 will not be damaged by the closing action of the gate valve 12. Furthermore, a curvature in the floor of the channel carrying the material may be provided to assist in this process.

It should be considered that any geometry of the channel 24 which results in an expansion of the cross-sectional area within the vicinity of the gate valve 12 from the storage compartment 1 side of the channel 24 to the discharge region 4 side of the channel 24 is within the scope of the present invention.

Hence, the cross-sectional area of the channel 24 in a first region, the first region being on the storage compartment 1 side of the gate valve 12, is less than the cross-sectional area of the channel 24 in a second region, the second region being on the discharge region 4 side of the gate valve 12. Notwithstanding this, the channel 24 may taper to a lesser cross-sectional area, or expand to a greater cross-sectional area at the discharge region 4.

Although at least some of the particles could pass through the gap remaining when the gate valve 12 is in the closed position, the flow of particles of the particulate material 2 is arrested by an agglomeration of the particles blocking the gap 26, hence further movement of the particles is prevented.

If a particle initially obstructs the gate valve 12 when the gate valve is being closed, the particle will be pushed towards the floor 27 and will not prevent the gate valve from attaining its ‘closed’ position, that is, particles do not hinder gate valve closure in this embodiment. The gate valve simply pushes particles out of the way, thus also preventing damage to particles.

It should be noted that many variations of this configuration may be envisaged and that all such variations in the configuration illustrated should be considered to fall within the scope of the present invention. For example, instead of providing a step the floor of the channel in, the region of the gate valve may be configured as a curve.

Thus, there has been provided in accordance with the present invention, an electronic dispenser device which satisfies the advantages set forth above.

The invention may also be said broadly to consist in the parts, elements and features referred to or indicated in the specification of the application, individually or collectively, in any or all combinations of two or more of said parts, elements or features, and where specific integers are mentioned herein which have known equivalents in the art to which the invention relates, such known equivalents are deemed to be incorporated herein as if individually set forth.

Although the preferred embodiment has been described in detail, it should be understood that various changes, substitutions, and alterations can be made herein by one of ordinary skill in the art without departing from the spirit or scope of the present invention.

The claims defining the invention are as follows:

1. A device for dispensing particulate material in a controlled manner, said device being portable and including;
a particulate material storage compartment;
a channel to transfer the particulate material from the storage compartment to a discharge region;
a gate valve, the gate valve passing through a slot in the channel wall, the slot disposed intermediate to the storage compartment and the discharge region; and
electronic control means to actuate the gate valve.

2. A device as claimed in claim 1, wherein the device is provided with carrying or support means to aid in the portability of the device.

3. A device for dispensing particulate material in a controlled manner, said device being automated and immobile, and including:
a particulate material storage compartment;
a channel to transfer the particulate material from a storage compartment to a discharge region;
a gate valve, the gate valve passing through a slot in the channel wall, the slot disposed intermediate to the storage compartment and the discharge region; and
electronic control means to actuate the gate valve.

4. A device as claimed in any one of the claims 1 to 3, wherein the channel has a discontinuity in cross-sectional area in the vicinity of the gate valve whereby the cross-sectional area of the channel in a first region, the first region being on the storage compartment side of the gate valve, is less than the cross-sectional area of the channel in a second region, the second region being on the discharge region side of the gate valve.

5. A device as claimed in any one of the claims 1 to 4, wherein at least part of the channel is tapered along the channel's longitudinal length.

6. A device as claimed in any one of the claims 1 to 5, wherein the channel includes a distinct step in the vicinity of the gate valve.

7. A device as claimed in any one of the claims 1 to 6, wherein the channel has a substantially uniform cross-sectional area along the longitudinal length of the channel.

8. A device as claimed in any one of the claims 1 to 7, wherein the cross-sectional geometry of the channel is any shape.

9. A device as claimed in any one of the claims 1 to 8, wherein the device is provided with electronic means to control the duration for which the gate valve is in an open position.

10. A device as claimed in any one of the claims 1 to 9, wherein the device is provided with electronic means to control the width of a gap produced when the gate valve is in the open position.

11. A device as claimed in any one of the claims 1 to 10, wherein the device derives electrical power from any of the following means: battery; re-chargeable battery; mains; stored capacitive and/or solar.

12. A device as claimed in any one of the claims 1 to 11, wherein the device includes indicators to show the status of the device.

13. A device as claimed in any one of the claims 1 to 12, wherein the device includes warning indicators.

14. A device as claimed in any one of the claims 1 to 13, wherein actuation means to actuate the gate valve includes at least one solenoid.

15. A device as claimed in any one of the claims 1 to 14, wherein the gate valve is a substantially planer sheet of substantially rigid material.

16. A device as claimed in any one of the claims 1 to 15, wherein when the gate-valve is in a closed position there remains a gap between the gate valve and the channel wall.

17. A device as claimed in any one of the claims 1 to 16, wherein the device is controlled by, or communicates with, a computer or the like.

18. A device as claimed in any one of the claims 1 to 17, wherein the gate valve is an air-operated gate valve or the like.

19. A portable electronic particulate material dispenser, substantially according to the embodiment described in the specification with reference to and as illustrated in the accompanying figures.

20. An immobile automated electronic particulate material dispenser, substantially according to the embodiment described in the specification with reference to the accompanying figures.
